(19) United States
(12) Patent Application Publication
(10) Pub. No.: US 2012/0134631 A1
(43) Pub. Date: May 31, 2012

(54) Molded Interconnect Device (MID) with Thermal Conductive Property and Method for Production Thereof

(75) Inventors: Cheng-Feng Chiang, Guishan Township (TW); Jung-Chuan Chiang, Guishan Township (TW); Wei-Cheng Fu, Guishan Township (TW)

(73) Assignee: KUANG HONG PRECISION CO., LTD., Guishan Township (TW)

(21) Appl. No.: 13/185,883

(22) Filed: Jul. 19, 2011

Related U.S. Application Data
(60) Provisional application No. 61/417,231, filed on Nov. 25, 2010.

(51) Int. Cl. G02B 6/36; B29C 45/14; B29C 35/08; B29C 70/00; H01R 43/00

(52) U.S. Cl. 385/88; 264/241; 216/13; 264/400; 264/129; 264/494

(57) ABSTRACT

A molded interconnect device (MID) with a thermal conductive property and a method for production thereof are disclosed. A thermal conductive element is set in a support element to improve the thermal conductivity of the support element, and the support element is a non-conductive support or a metallizable support. A metallization layer is formed on a surface of the support element. If a heat source is set on the metallization layer, heat produced by the heat source will pass out from the metallization layer or the support element with the thermal conductivity material element.

### RELATED APPLICATION

This application claims the priority benefit of co-pending U.S. provisional application 61/417,231, filed on Nov. 25, 2010, the entire specification of which is incorporated by reference.

### FIELD OF THE INVENTION

The present invention relates to a molded interconnect device (MID) and a manufacturing method thereof, in particular to a molded interconnect device (MID) with a thermal conductive property and a method for production thereof.

### BACKGROUND OF THE INVENTION

In a general circuit design, the circuit is designed on a flat board. Since the circuit board is usually a flat board or a sheet structure, therefore it is necessary to provide space for accommodating the circuit when circuit related products are designed, and such requirement is inconvenient. Therefore, some manufacturers start integrating the circuit into the product to form the so-called “molded interconnect device (MID)”.

MID refers to a device produced by manufacturing conducting wires or patterns with electric functions onto an injection molded plastic casing to achieve the effect of integrating a general circuit board with plastic protection and support functions to form a stereoscopic circuit carrier. MID further has the advantage of selecting a desired shape for the design, so that the circuit design is no longer limited to the flat circuit board only, and the circuit can be designed according to the shape of the plastic casing. At present, the MID has be used extensively in the areas of automobile, industry, computers or communication, etc.

However, it is mandatory to take the heat dissipation issue into consideration for the design of electric appliance related products. Since a portion of energy will be converted into heat energy by the resistance of the circuit when electric current is passed through the circuit, the heat energy will be accumulated to increase the ambient temperature of the electric appliance continuously. The heat energy may even damage the electric appliance or cause a fire accident. In other words, the heat dissipation issue exists whenever there is an electric product.

### SUMMARY OF THE INVENTION

In view of the shortcomings of the prior art, it is a primary objective of the present invention to provide a molded interconnect device (MID) with a thermal conductive property and a method for production thereof to overcome the heat dissipation problem.

To achieve the foregoing objective, the present invention provides a molded interconnect device (MID) with a thermal conductive property comprising: a support element, a thermal conductive element and a metallization layer. Wherein, the thermal conductive element is disposed in the support element and the support element is a non-conductive support or a metallizable support. The metallization layer is formed on a surface of the support element. To improve the conductivity of the support element, the support element further comprises a heat column penetrated and installed in the support element, such that heat can be conducted and dissipated through the support element.

In addition, the molded interconnect device (MID) with a thermal conductive property of the present invention can have a non-conductive metal composite set in a non-conductive support or on a surface of the non-conductive support according to different processes of manufacturing the metallization layer. It is noteworthy to point out that after the non-conductive metal composite is irradiated by the electromagnetic radiation, the non-conductive metal composite will receive energy of the electromagnetic radiation to form the metal nuclei that serves as a catalyst. In a chemical plating process, the metal nuclei can catalyze metal ions in an electroless plating solution, and the chemical reduction reaction takes place to form a metallization layer on a surface of a predetermined circuit structure. Wherein, the non-conductive metal composite is a thermally stable inorganic oxide and comprises a higher oxide with a spinel structure or a combination thereof.

Moreover, in the molded interconnect device (MID) with a thermal conductive property of the present invention, an electroplatable colloid can be formed on the non-conductive support. Wherein, when a metal is electroplated on the non-conductive support, the metal will be attached onto the non-conductive support containing the electroplatable colloid.

In addition, the molded interconnect device (MID) with a thermal conductive property of the present invention can further use a thin film containing micro/nano metal particles to form the metallization layer. More specifically, the foregoing thin film is formed on the support element, and the support element is a non-conductive support. After the thin film is irradiated and heated by the electromagnetic radiation directly or indirectly, the micro/nano metal particles will be fused and combined with the non-conductive support to form the metallization layer. After the metallization layer is formed by the aforementioned method, the thin film containing the micro/nano metal particles without being heated by the electromagnetic radiation can be recycled to reduce the material cost of the molded interconnect device (MID) with a thermal conductive property.

The present invention further provides a manufacturing method of a molded interconnect device (MID) with a thermal conductive property, and the method comprises the steps of: providing a support element and a thermal conductive element, and the support element is a non-conductive support or a metallizable support, wherein the thermal conductive element is distributed in the support element; and providing a metallization layer, wherein the metallization layer is formed on a surface of the support element. In practical applications, the support element is a non-conductive support, and the non-conductive metal composite is set in the non-conductive support or on a surface of the non-conductive support. After the non-conductive metal composite is exposed in the electromagnetic radiation to produce the metal nuclei, the metal nuclei is distributed on the surface of the non-conductive support to form the metallization layer. Wherein, the non-conductive metal composite is a thermally stable inorganic oxide and comprises a higher oxide with a spinel structure and a combination thereof. In other words, the foregoing method of adding the non-conductive metal composite to the non-conductive support can use the method of exposing in the electromagnetic radiation to release the metal nuclei from the non-conductive metal composite to facilitate the formation of the metallization layer on the surface of the non-conductive support. The method of irradiating in electromagnetic radiations is called laser direct structuring (LDS).

In addition to the method of irradiating by the electromagnetic radiation to form the metallization layer, an electroplatable colloid can be coated on the surface of the non-conductive support, so that a metal can be electroplated onto the surface of the non-conductive support directly. It is noteworthy to point out that different methods can be adopted according to different requirements, and the first method forms the metallization layer on the surface of the non-conductive support by a direct electroplating method, and then provides another non-conductive support containing the thermal conductive element, and finally forms the non-conductive support containing the metallization layer onto the other non-conductive support by the insert injection molding method; and the second method provides another non-conductive support containing the thermal conductive element and forms the non-conductive support on the other non-conductive support by the insert injection molding method, before the metallization layer is formed on the surface of the non-conductive support by a direct electroplating method.

In addition, the present invention also can use the double injection molding or insert injection molding method to form the metallization layer. Wherein, before the metallization layer is provided, the surface of the support element is etched first, and the metal catalyst is provided and distributed on the surface after the etching step. In the double injection molding method, the support element is used as an example of the metallizable support, and before or after the step of providing the metallizable support and the thermal conductive element, a non-metallizable support containing the thermal conductive element is further provided. Wherein, the non-metallizable support containing the thermal conductive element and the metallizable support containing the thermal conductive element are formed by the double injection molding method, and then the etching step takes place, and the metal catalyst is provided and the metallization layer is formed. If the insert injection molding method is adopted, two embodiments can be used according to different manufacturing processes. In the first embodiment, another non-conductive support of the thermal conductive element and the metallizable support containing the thermal conductive element are formed by the insert injection molding method, and then the metallization layer is formed on the etched surface after the etching step. In the second embodiment, the metallizable support containing the thermal conductive element is coated onto the etched surface to form the metallization layer first, and then the other non-conductive support containing the thermal conductive element and the metallizable support containing the thermal conductive element are formed by the insert injection molding method.

In the manufacturing method of the molded interconnect device (MID) with a thermal conductive property addition in accordance with the present invention, the support element is a non-conductive support used in the step of forming the metallization layer, and a thin film containing micro/nano metal particles is formed on the non-conductive support. After the thin film containing the micro/nano metal particles are irradiated and heated by the electromagnetic radiation directly or indirectly, the micro/nano metal particles will be fused and combined to the non-conductive support to form the metallization layer.

In summation, the molded interconnect device (MID) with a thermal conductive property of the present invention and the method for production thereof have the following advantages:

1. In the molded interconnect device (MID) with a thermal conductive property and the method for production thereof in accordance with the present invention, the thermal conductive element is added into the support element to improve the thermal conducting effect of the support element. The support element can be a non-conductive support or a metallizable support.

2. In the molded interconnect device (MID) with a thermal conductive property and the method for production thereof in accordance with the present invention, the MID can be formed by a laser, double injection molding, insert injection molding or direct electroplating method.

The technical characteristics and effects of the present invention will become apparent in the detailed description of the preferred embodiments with reference to the accompanying drawings as follows.

### BRIEF DESCRIPTION OF THE DRAWINGS

FIG. 1 is a schematic view of a molded interconnect device (MID) with a thermal conductive property in accordance with a first preferred embodiment of the present invention;

FIG. 2 is a schematic view of a molded interconnect device (MID) with a thermal conductive property in accordance with a second preferred embodiment of the present invention;

FIG. 3a is a first flow chart of manufacturing a molded interconnect device (MID) with a thermal conductive property in accordance with a third preferred embodiment of the present invention;

FIG. 3b is a second flow chart of manufacturing a molded interconnect device (MID) with a thermal conductive property in accordance with a third preferred embodiment of the present invention;

FIG. 3c is a third flow chart of manufacturing a molded interconnect device

(MID) with a thermal conductive property in accordance with a third preferred embodiment of the present invention;

FIG. 4a is a first flow chart of manufacturing a molded interconnect device (MID) with a thermal conductive property in accordance with a fourth preferred embodiment of the present invention;

FIG. 4b is a second flow chart of manufacturing a molded interconnect device (MID) with a thermal conductive property in accordance with a fourth preferred embodiment of the present invention;

FIG. 4c is a third flow chart of manufacturing a molded interconnect device (MID) with a thermal conductive property in accordance with a fourth preferred embodiment of the present invention;

FIG. 5a is a first flow chart of manufacturing a molded interconnect device (MID) with a thermal conductive property in accordance with a fifth preferred embodiment of the present invention;

FIG. 5b is a second flow chart of manufacturing a molded interconnect device (MID) with a thermal conductive property in accordance with a fifth preferred embodiment of the present invention;

FIG. 5c is a third flow chart of a first processing procedure of manufacturing a molded interconnect device (MID) with a thermal conductive property in accordance with a fifth preferred embodiment of the present invention;

FIG. 5d is a fourth flow chart of a first processing procedure of manufacturing a molded interconnect device (MID) with a thermal conductive property in accordance with a fifth preferred embodiment of the present invention;

FIG. 5e is a third flow chart of a second processing procedure of manufacturing a molded interconnect device (MID) with a thermal conductive property in accordance with a fifth preferred embodiment of the present invention;

FIG. 5f is a fourth flow chart of a second processing procedure of manufacturing a molded interconnect device (MID) with a thermal conductive property in accordance with a fifth preferred embodiment of the present invention;

FIG. 6a is a first flow chart of manufacturing a molded interconnect device (MID) with a thermal conductive property in accordance with a sixth preferred embodiment of the present invention;

FIG. 6b is a second flow chart of manufacturing a molded interconnect device (MID) with a thermal conductive property in accordance with a sixth preferred embodiment of the present invention;

FIG. 6c is a third flow chart of manufacturing a molded interconnect device

(MID) with a thermal conductive property in accordance with a sixth preferred embodiment of the present invention;

FIG. 7a is a first flow chart of manufacturing a molded interconnect device (MID) with a thermal conductive property in accordance with a seventh preferred embodiment of the present invention;

FIG. 7b is a second flow chart of manufacturing a molded interconnect device (MID) with a thermal conductive property in accordance with a seventh preferred embodiment of the present invention;

FIG. 7c is a third flow chart of manufacturing a molded interconnect device (MID) with a thermal conductive property in accordance with a seventh preferred embodiment of the present invention;

FIG. 7d is a fourth flow chart of a first processing procedure of manufacturing a molded interconnect device (MID) with a thermal conductive property in accordance with a seventh preferred embodiment of the present invention;

FIG. 7e is a fifth flow chart of a first processing procedure of manufacturing a molded interconnect device (MID) with a thermal conductive property in accordance with a seventh preferred embodiment of the present invention;

FIG. 7f is a fourth flow chart of a second processing procedure of manufacturing a molded interconnect device (MID) with a thermal conductive property in accordance with a seventh preferred embodiment of the present invention;

FIG. 7g is a fifth flow chart of a second processing procedure of manufacturing a molded interconnect device (MID) with a thermal conductive property in accordance with a seventh preferred embodiment of the present invention;

FIG. 8 is a schematic view of a molded interconnect device (MID) with a thermal conductive property in accordance with an eighth preferred embodiment of the present invention;

FIG. 9a is a first flow chart of manufacturing a molded interconnect device (MID) with a thermal conductive property in accordance with a ninth preferred embodiment of the present invention;

FIG. 9b is a second flow chart of manufacturing a molded interconnect device (MID) with a thermal conductive property in accordance with a ninth preferred embodiment of the present invention;

FIG. 9c is a third flow chart of manufacturing a molded interconnect device (MID) with a thermal conductive property in accordance with a ninth preferred embodiment of the present invention; and

FIG. 9d is a fourth flow chart of manufacturing a molded interconnect device (MID) with a thermal conductive property in accordance with a ninth preferred embodiment of the present invention.

### DESCRIPTION OF THE PREFERRED EMBODIMENTS

The technical characteristics and contents of the present invention will become apparent with the following detailed description and related drawings. It is noteworthy to point out that same numerals are used for representing respective same elements in the drawings.

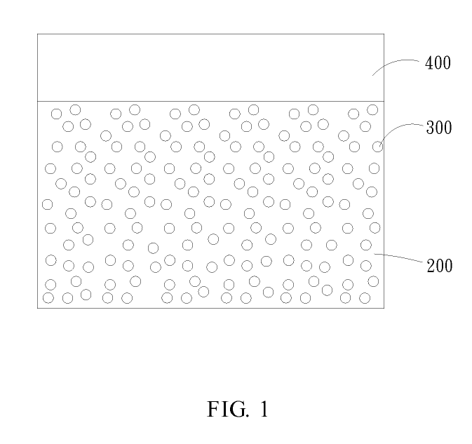

With reference to FIG. 1 for a schematic view of a molded interconnect device (MID) with a thermal conductive property in accordance with a first preferred embodiment of the present invention. Wherein, the molded interconnect device (MID) with a thermal conductive property comprises a support element, a thermal conductive element 300 and a metallization layer 400. Wherein, the support element is a non-conductive support 200 or a metallizable support. In the first preferred embodiment, the support element is the non-conductive support 200. Wherein, the thermal conductive element 300 is set in the non-conductive support 200, and the metallization layer 400 is formed on a surface of the non-conductive support 200. The material of the thermal conductive element 300 can be a metal, a non-metal or combination thereof. The material of the metal of the thermal conductive element 300 is lead, aluminum, gold, copper, tungsten, magnesium, molybdenum, zinc, silver, or any combination thereof; or the material of the non-metal of the thermal conductive element 300 includes graphite, grapheme, diamond, carbon nanotube, carbon nanocapsule, nanofoam, fullerene, carbon nanocone, carbon nanohorn, carbon nanopipet, carbon microtree, beryllium oxide, aluminum oxide, boron nitride, aluminum nitride, magnesium oxide, silicon nitride, silicon carbide, or any combination thereof. In addition, the non-conductive support 200 can be a thermoplastic synthetic resin or a thermosetting synthetic resin, and the non-conductive support 200 further comprises at least one inorganic filler, and the material of the inorganic filler can be a silicate, a silicate derivative, a carbonate, a carbonate derivative, a phosphate, a phosphate derivative, activated carbon, porous carbon, carbon nanotube, graphite, zeolite, clay mineral, ceramic powder, chitin or any combination thereof. It is noteworthy to point out that the molded interconnect device (MID) with a thermal conductive property includes a thermal conductive element 300 set in the non-conductive support 200 to improve the heat conductive effect.

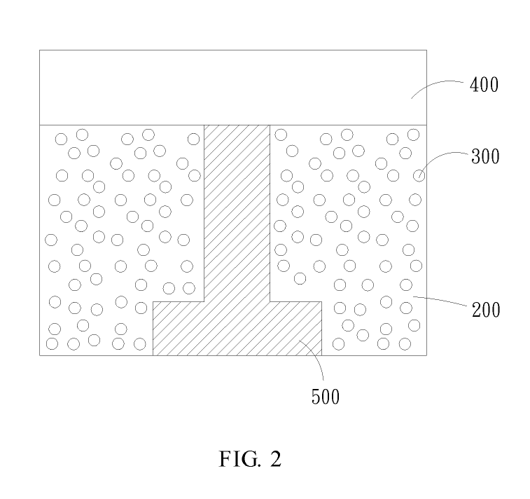

With reference to FIG. 2 for a schematic view of a molded interconnect device (MID) with a thermal conductive property in accordance with a second preferred embodiment of the present invention. The molded interconnect device (MID) with a thermal conductive property comprises a non-conductive support 200 set in the thermal conductive element 300 and further comprises a heat column 500 penetrated and disposed in the non-conductive support 200, and a metallization layer 400 formed on a surface of the non-conductive support 200. Wherein, the material of the heat column 500 can be lead, aluminum, gold, copper, tungsten, magnesium, molybdenum, zinc, silver, graphite, grapheme, diamond, carbon nanotube, carbon nanocapsule, nanofoam, fullerene, carbon nanocone, carbon nanohorn, carbon nanopipet, carbon microtree, beryllium oxide, aluminum oxide, boron nitride, aluminum nitride, magnesium oxide, silicon nitride, silicon carbide, or any combination thereof.

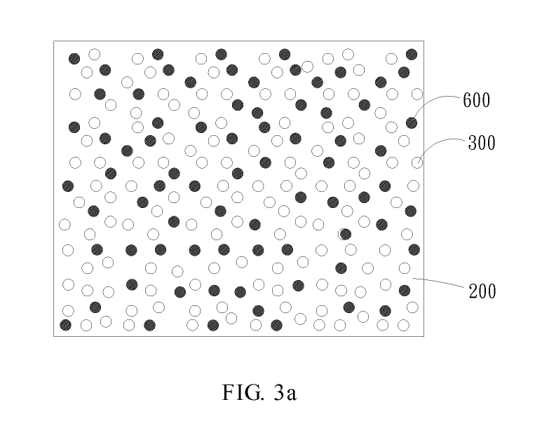

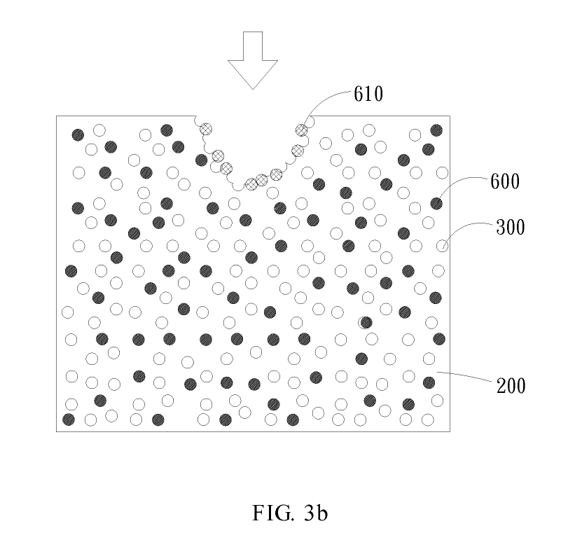

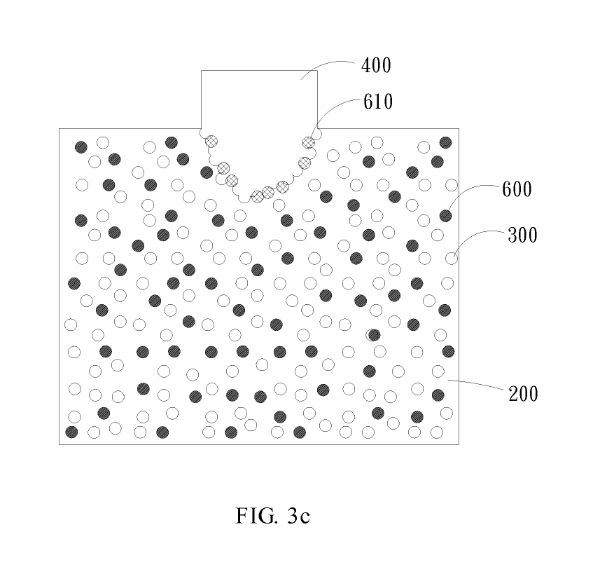

It is noteworthy to point out that when the metallization layer is formed on the non-conductive support, an indirect catalyst can be used to form the metallization layer on the non-conductive support, wherein the indirect catalyst has its properties when it goes through the excitation of physical energy, bond breaking or chemical redox reactions. If the indirect catalyst has not changed to the catalyst yet, then the indirect catalyst will not have the properties of the catalyst. The property of the catalyst can be used for forming a metal on the non-conductive support. In other words, the aforementioned property of the indirect catalyst can be used for forming a metallization layer on a specified area. With reference to FIGS. 3a, 3b and 3c for the first, second and third flow charts of manufacturing a molded interconnect device (MID) with a thermal conductive property in accordance with a third preferred embodiment of the present invention respectively. Wherein, the arrowhead in FIG. 3b shows the electromagnetic radiation applied to a surface of the non-conductive support, and the electromagnetic radiation in practical applications can be a laser radiation with a wavelength from 248 nm to 10600 nm, and the laser radiation includes carbon dioxide (CO₂) laser, Nd:YAG laser, Nd:YVO₄ laser, excimer laser or fiber laser). In FIGS. 3a, 3b and 3c, the present invention further provides the LDS to form the metallization layer 400. In addition to the thermal conductive element 300, the non-conductive support 200 further includes a non-conductive metal composite 600. Wherein, the non-conductive metal composite 600 can be set on a surface of the non-conductive support 200 and used as an indirect catalyst, and the non-conductive metal composite 600 can be a thermally stable inorganic oxide and comprise a higher oxide with a spinel structure. The material of the non-conductive metal composite 600 can be copper, silver, palladium, iron, nickel, vanadium, cobalt, zinc, platinum, iridium, osmium, rhodium, rhenium, ruthenium, tin or any combination thereof. If a physical etch is applied to the surface of the non-conductive support 200, such as laser is applied to the surface of non-conductive support 200, the non-conductive metal composite 600 will receive the large amount of high energy of the laser to form a plurality of metal nuclei 610, and the metallization layer 400 can be formed on the non-conductive support 200 containing the metal nuclei 610 by a chemical reduction. More specifically, the laser radiation can irradiate selectively on any particular position of the non-conductive support 200 to form the metallization layer 400. In addition, the non-conductive support 200 includes at least one inorganic filler. It is noteworthy to point out that the non-conductive support 200, the thermal conductive element 300 and the inorganic filler are made of materials as described in the foregoing preferred embodiments, and thus will not be described here again.

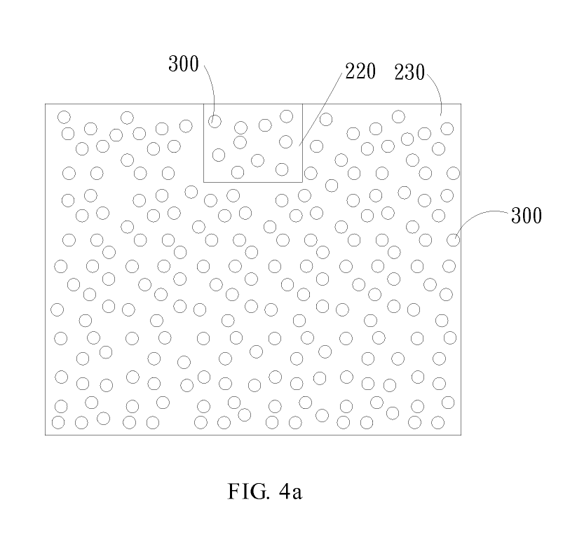

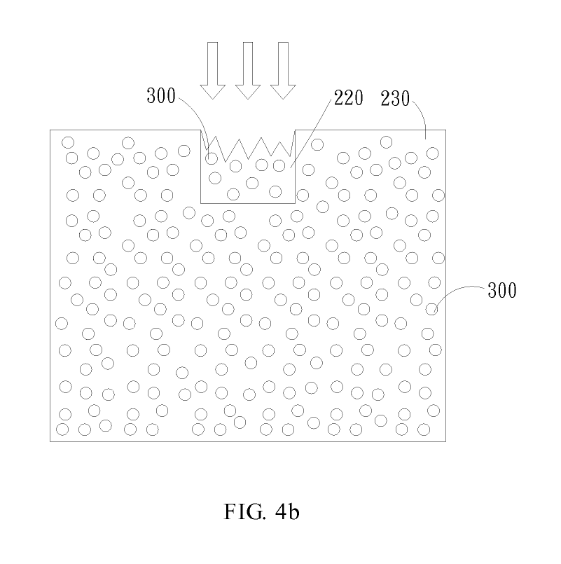

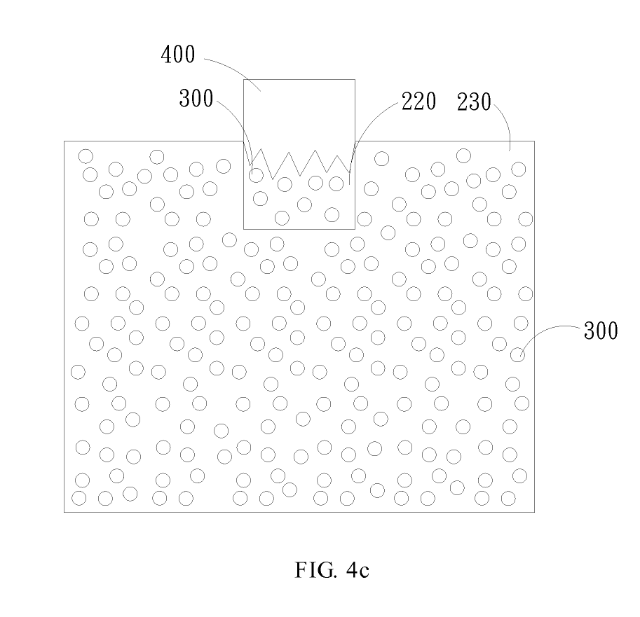

With reference to FIGS. 4a, 4b and 4c for the first, second and third flow charts of manufacturing a molded interconnect device (MID) with a thermal conductive property in accordance with a fourth preferred embodiment of the present invention respectively, the invention further uses a chemical etching process to form the metallization layer on the non-conductive support. Wherein, the arrowhead in FIG. 4b shows an etching applied to a surface of the metallizable support. Firstly, a metallizable support 220 containing a thermal conductive element 300 is provided, and then a non-metallizable support 230 containing the thermal conductive element 300 is further provided. It is noteworthy to point out that the non-metallizable support 230 containing the thermal conductive element 300 can be provided first, and then the metallizable support 220 containing the thermal conductive element 300 is provided. The metallizable support 220 containing the thermal conductive element 300 and the non-metallizable support 230 containing the thermal conductive element 300 are formed by a double injection molding method. Wherein, a surface of the metallizable support 220 is exposed, and a support formed by the double injection molding process is provided for performing a chemical etch. Wherein, after the chemical etch of the metallizable support 220 takes place, a metal catalyst (not shown in the figure) is applied to the etched area, and the material of the metal catalyst (not shown in the figure) can be silver, palladium, iron, nickel, copper, vanadium, cobalt, zinc, platinum, iridium, osmium, rhodium, rhenium, ruthenium, tin or any combination thereof. Then, a chemical reduction of the etched metallizable support 220 is performed to form the metallization layer 400. It is noteworthy to point out that the present invention can also use a physical etch method to substitute the aforementioned chemical etch method. In addition, the thermal conductive element 300 is a metal or a non-metal. The material of the metal of the thermal conductive element 300 can be lead, aluminum, gold, copper, tungsten, magnesium, molybdenum, zinc, silver or their combination, and the non-metal of the thermal conductive element 300 includes graphite, grapheme, diamond, carbon nanotube, carbon nanocapsule, nanofoam, fullerene, carbon nanocone, carbon nanohorn, carbon nanopipet, carbon microtree, beryllium oxide, aluminum oxide, boron nitride, aluminum nitride, magnesium oxide, silicon nitride, silicon carbide, or any combination thereof.

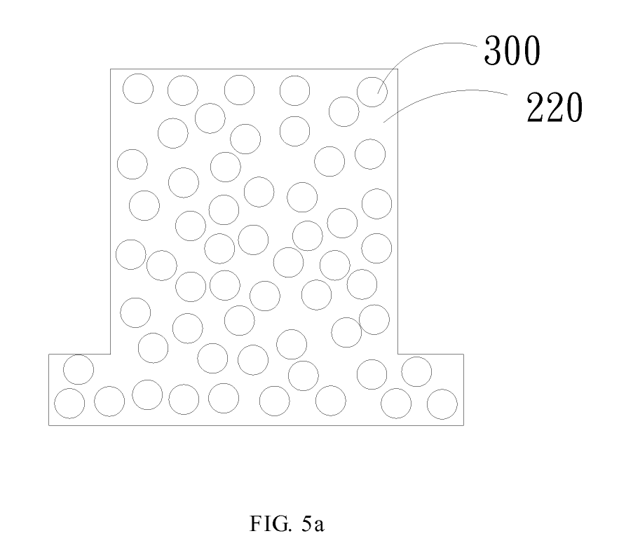

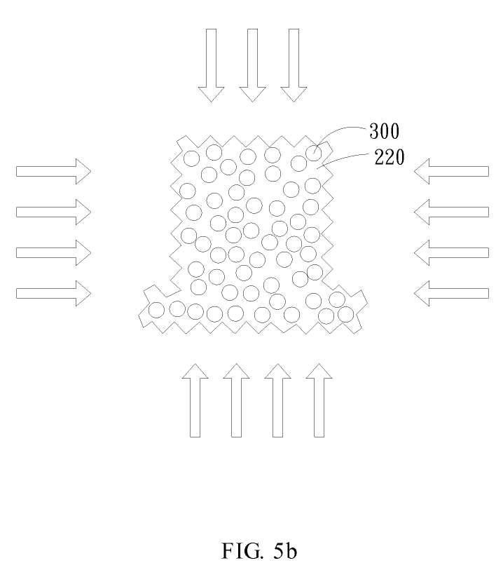

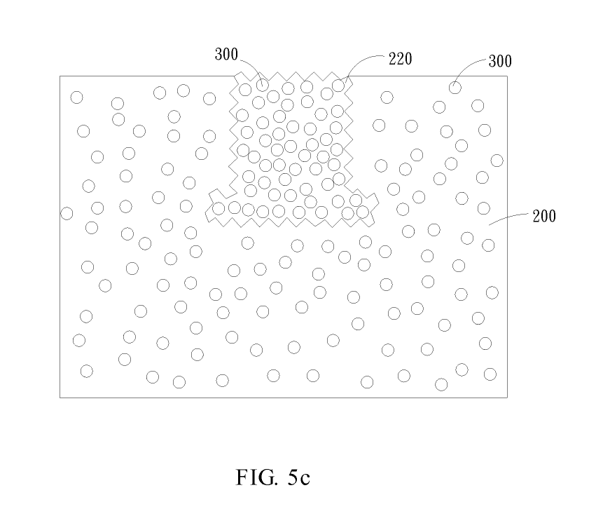

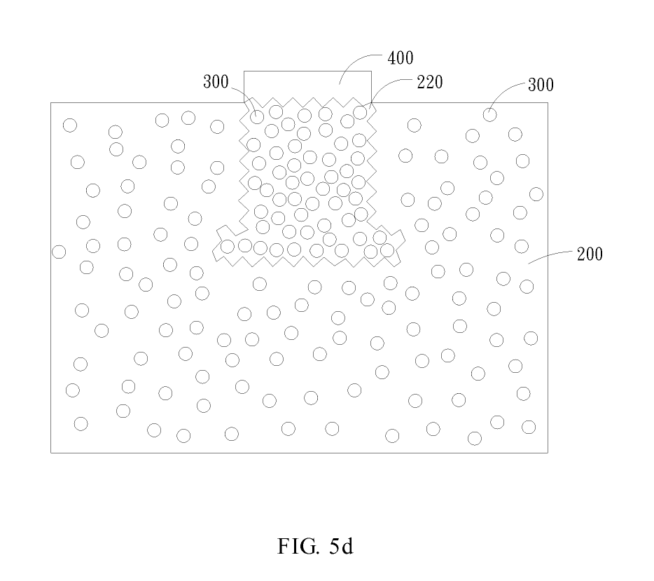

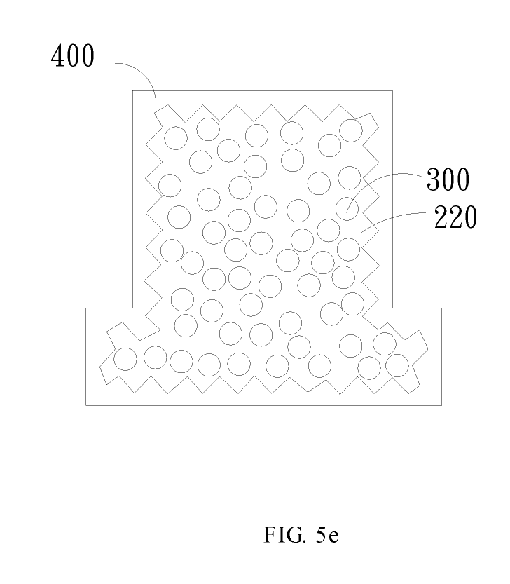

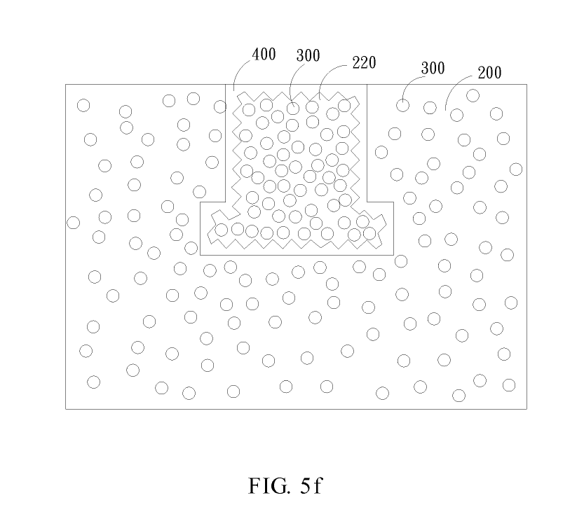

With reference to FIGS. 5a and 5b for the first and second flow charts of manufacturing a molded interconnect device (MID) with a thermal conductive property in accordance with a fifth preferred embodiment of the present invention respectively. Wherein, the arrowhead of FIG. 5b shows an etching applied to a surface of the metallizable support 220. In FIGS. 5a and 5b, the metallizable support 220 containing the thermal conductive element 300 is provided. For example, an injection molding method is used for forming the metallizable support 220 containing the thermal conductive element 300, and then a physical or chemical etch of the metallizable support 220 is formed, and two different processing procedures are carried out according to the features of the products. With reference to FIGS. 5c and 5d for the third and fourth flow charts of manufacturing a molded interconnect device (MID) with a thermal conductive property in accordance with a fifth preferred embodiment of the present invention in the first processing procedure respectively, the first processing procedure provides the non-conductive support 200 containing the thermal conductive element 300, and the metallizable support 220 is formed on the non-conductive support 200 by an insert injection molding method, and then the metallization layer 400 is formed on the metallizable support 220 by the chemical reduction. With reference to FIGS. 5e and 5f for the third and fourth flow charts of manufacturing a molded interconnect device (MID) with a thermal conductive property in the second processing procedure in accordance with a fifth preferred embodiment of the present invention respectively. The metallizable support 220 containing the thermal conductive element 300 is processed by the chemical reduction to form the metallization layer 400, then the non-conductive support 200 containing the thermal conductive element 300 is provided, and the metallizable support 220 containing the metallization layer 400 is formed on the non-conductive support 200 by an insert injection molding method. In addition, the etching method includes a physical etch or a chemical etch. It is noteworthy to point out that before the metallization layer is formed, and a metal catalyst (not shown in the figure) is provided and distributed on the etched surface of the metallizable support 220. In addition, the thermal conductive element 300 and the metal catalyst (not shown in the figure) are made of materials as described above, and thus will not be described here again.

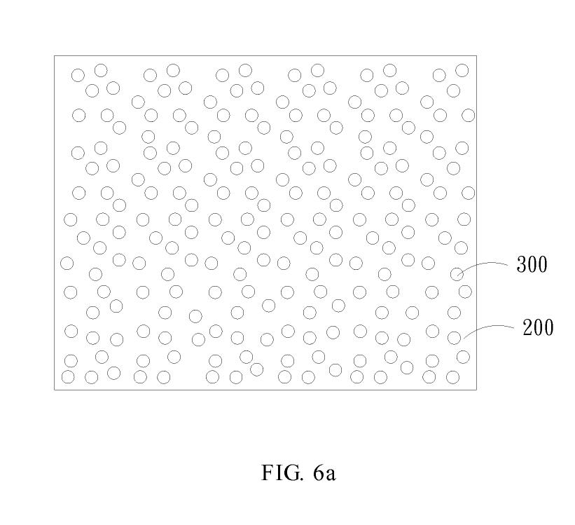

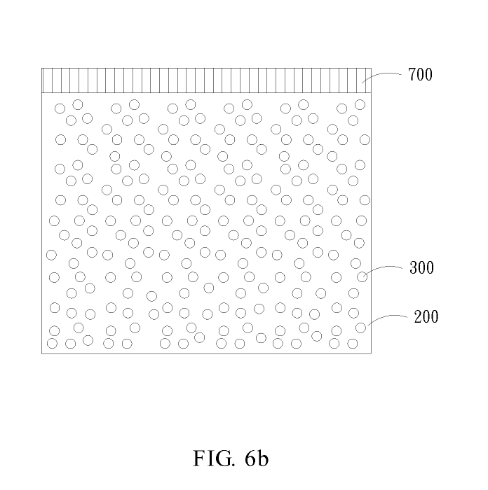

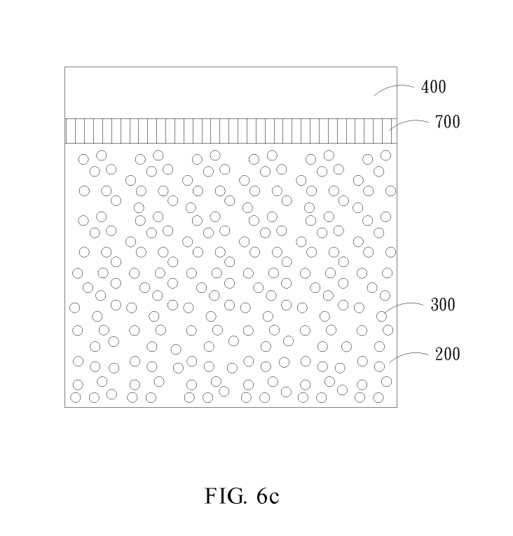

With reference to FIGS. 6a, 6b and 6c for the first, second and third flow charts of manufacturing a molded interconnect device (MID) with a thermal conductive property in accordance with a sixth preferred embodiment of the present invention respectively, an electroplatable colloid 700 is formed on the non-conductive support 200 containing the thermal conductive element 300. The material of the electroplatable colloid 700 is palladium, carbon/graphite, conductive polymer or combination thereof. It is noteworthy to point out that the electroplatable colloid 700 is a conductive layer. A conductive layer is formed at a corresponding position on the non-conductive support 200 according to user requirements, and then a direct electroplating method is used for forming the metallization layer 400 at the position containing the conductive layer.

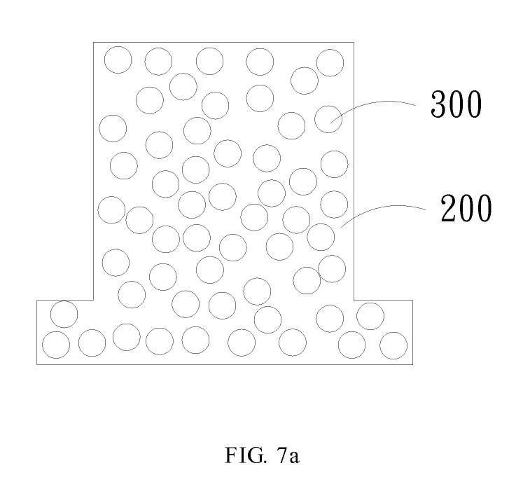

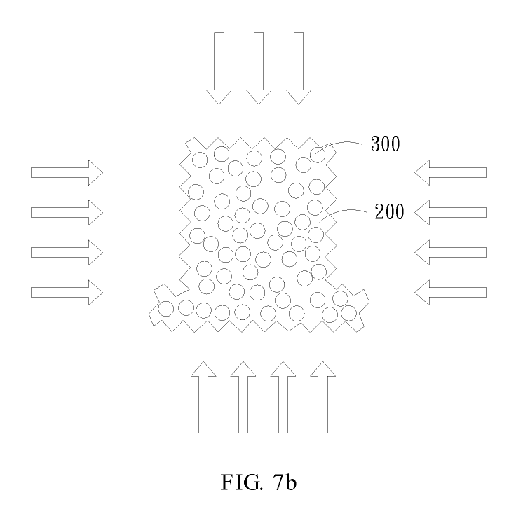

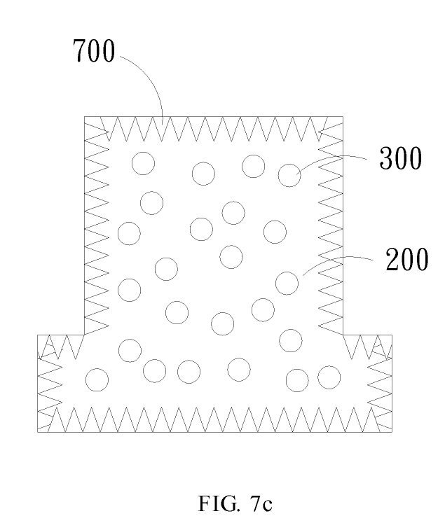

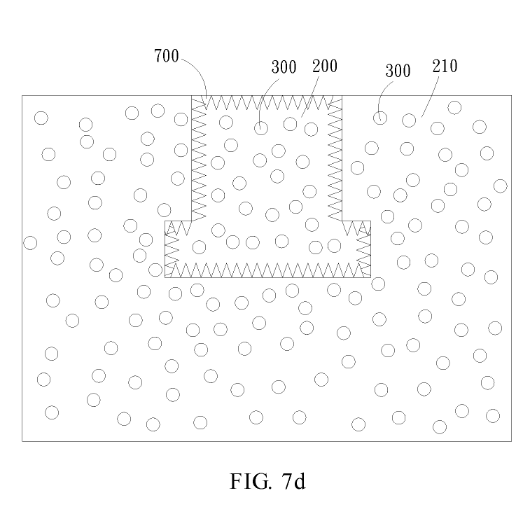

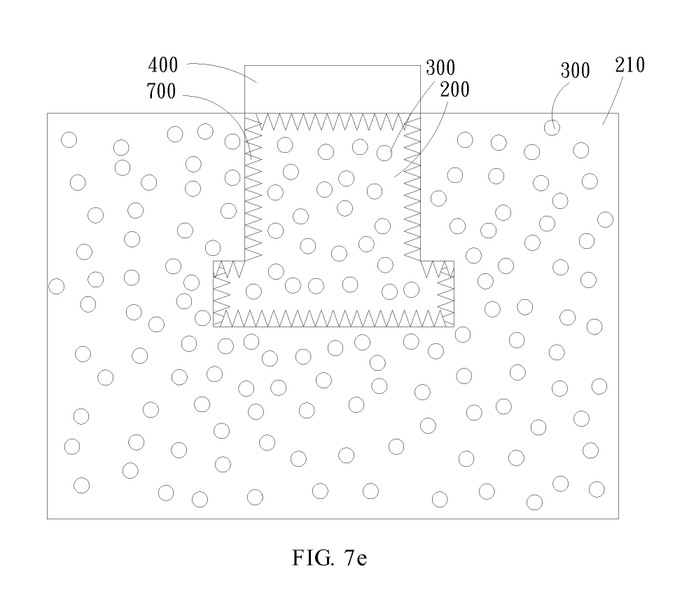

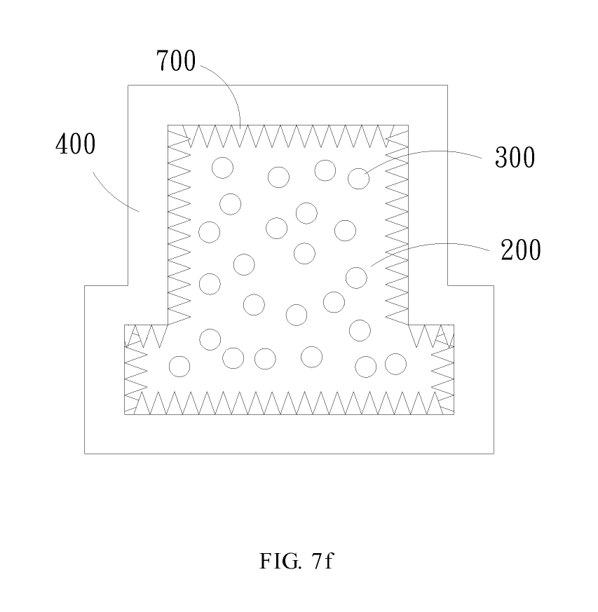

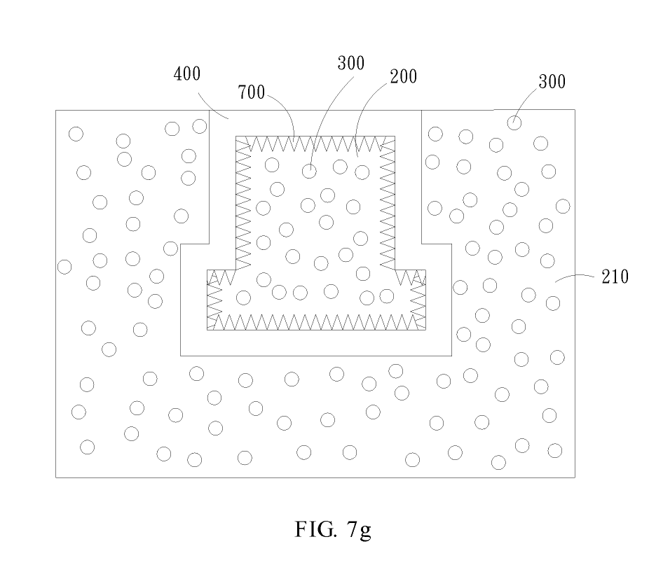

In addition, there are two ways of forming the metallization layer by the electroplatable colloid. With reference to FIGS. 7a, 7b and 7c for the first, second and third flow charts of manufacturing a molded interconnect device (MID) with a thermal conductive property in accordance with a seventh preferred embodiment of the present invention respectively. Wherein, the arrowhead in FIG. 7b shows an etching applied to a surface of the non-conductive support. In FIGS. 7a, 7b and 7c, the non-conductive support 200 containing the thermal conductive element 300 is etched, and an electroplatable colloid 700 is formed at the etched position, and two different processing procedures can be adopted according to the properties of the product. With reference to FIGS. 7d and 7e for the fourth and fifth flow charts of manufacturing a molded interconnect device (MID) with a thermal conductive property in the first processing procedure in accordance with a seventh preferred embodiment of the present invention respectively. Wherein, the first processing procedure provides another non-conductive support 210 containing the thermal conductive element 300 and forms the non-conductive support 200 on the other non-conductive support 210 by an insert injection molding method, and then a direct electroplating method is used for forming the metallization layer 400 on the non-conductive support 200. With reference to FIGS. 7f and 7g for the fourth and fifth flow charts of manufacturing a molded interconnect device (MID) with a thermal conductive property in the second processing procedure in accordance with a seventh preferred embodiment of the present invention respectively. The second processing procedure electroplates the non-conductive support 200 containing the thermal conductive element 300 covered with the electroplatable colloid 700 directly to form the metallization layer 400, then provides another non-conductive support 210 containing the thermal conductive element 300, and forms the non-conductive support 200 containing the metallization layer 400 on the other non-conductive support 210 by the insert injection molding method.

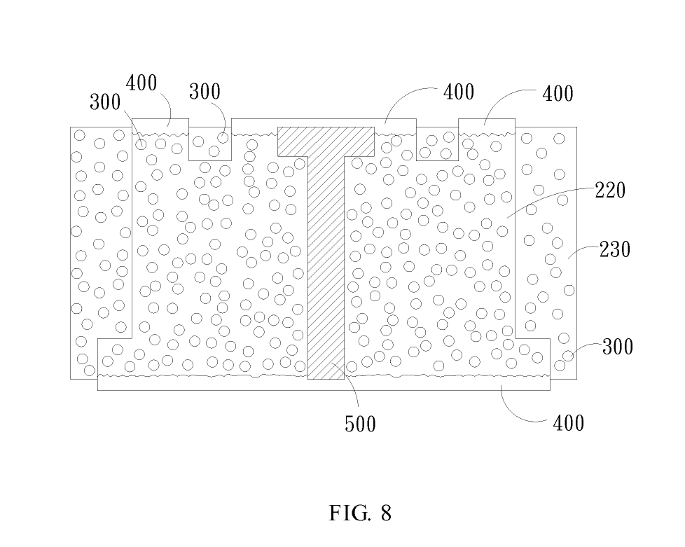

With reference to FIG. 8 for a schematic view of a molded interconnect device (MID) with a thermal conductive property in accordance with an eighth preferred embodiment of the present invention. Wherein, the non-metallizable support 230 includes a metallizable support 220 containing a thermal conductive element 300, the metallizable support 220 includes a heat column 500 penetrated therein, and a metallization layer 400 is formed separately on upper and lower surfaces of the metallizable support 220. Further, the non-metallizable support 230 can be substituted by a non-conductive support. For example, a heat source is set on the metallization layer 400 at the middle of the upper surface of metallizable support 220, and the heat source may be produced by a chip, a processor, or any other component. Since a portion of electric power is converted into heat energy after a general electric appliance is electrically connected, therefore the heat energy may cause high temperature to the chip or processor or even burn or damage the electric appliance. In this preferred embodiment, when heat is generated from the heat source, the temperature rises. At this moment, the metallization layer 400 at the middle of the upper surface of the metallizable support 220 will transmit the heat to the lower surface of the metallizable support 220 through the heat column 500, or the heat is dissipated to other positions with a lower temperature through the thermal conductive element 300 in the metallizable support 220. It is noteworthy to point out that the metallization layer 400 can be served as a circuit of the chip or processor such as the metallization layer 400 on both left and right sides of the upper surface of the metallizable support 220, in addition to its function of transmitting heat.

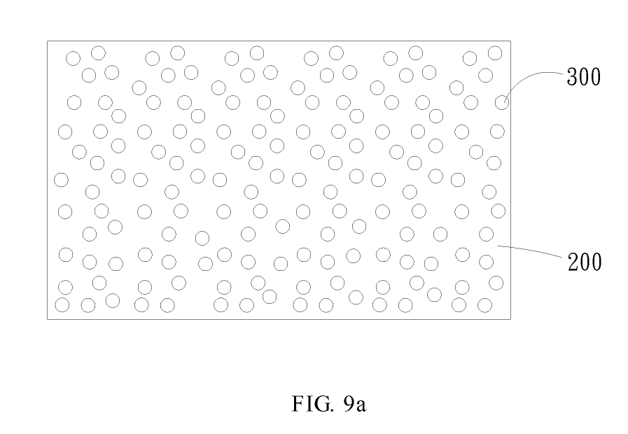

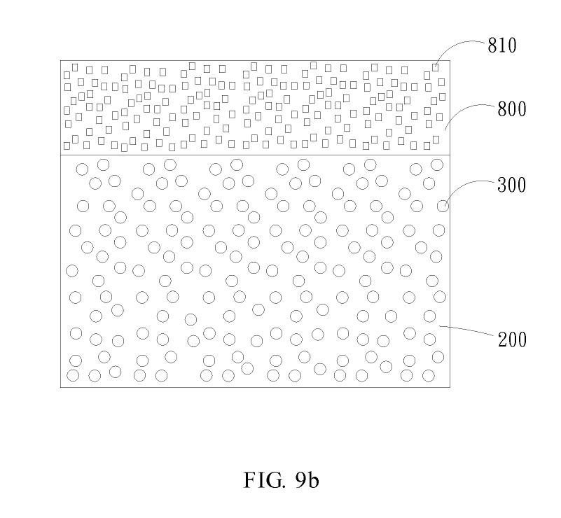

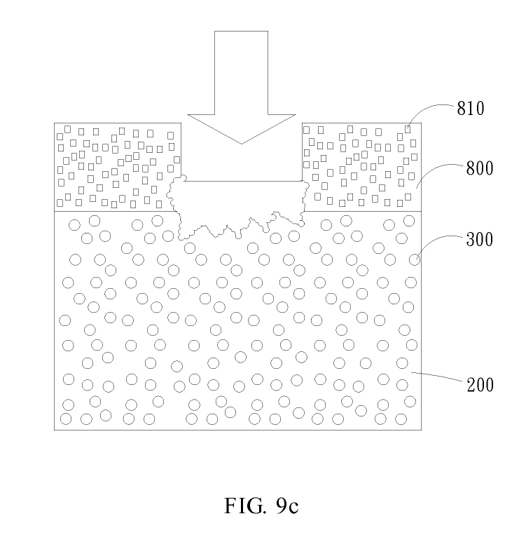

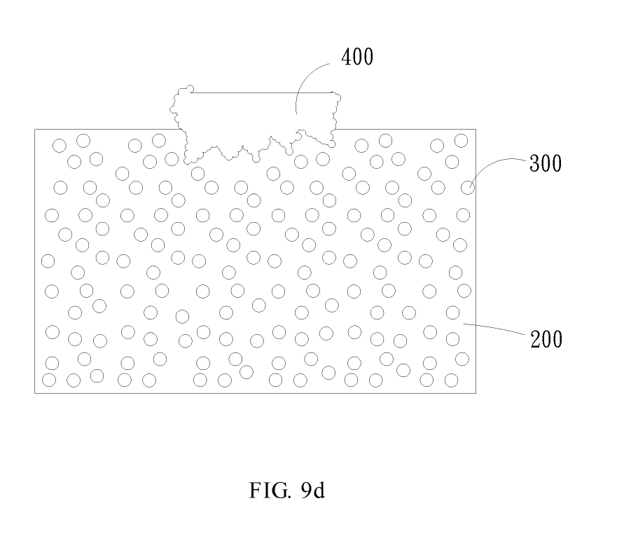

The present invention further provides another way of forming the molded interconnect device (MID) with a thermal conductive property by using a thin film containing a plurality of micro/nano metal particles to form the foregoing metallization layer. With reference to FIGS. 9a to 9d for the first, second, third and fourth flow charts of manufacturing a molded interconnect device (MID) with a thermal conductive property in accordance with a ninth preferred embodiment of the present invention respectively. Wherein, the arrowhead in FIG. 9c shows the area of thin film being irradiated and heated by the electromagnetic radiation. Firstly, the non-conductive support 200 containing the thermal conductive element 300 is provided, and then a thin film 800 containing the micro/nano metal particle 810 is set on the non-conductive support 200. Then, an area for forming the metallization layer is selected and irradiated and heated directly or indirectly by the electromagnetic radiation, and the micro/nano metal particles 810 will be fused and combined with the non-conductive support 200 to form the metallization layer 400, and finally the thin film 800 of the micro/nano metal particles 810 not combined with the non-conductive support 200 is removed. Wherein, the material of the micro/nano metal particles 810 can be titanium, antimony, silver, palladium, iron, nickel, copper, vanadium, cobalt, zinc, platinum, iridium, osmium, rhodium, rhenium, ruthenium, tin or any mixture or combination thereof. It is noteworthy to point out that the thin film 800 containing the micro/nano metal particles 810 heated directly by the way of the electromagnetic radiation refers to the thin film 800 containing the micro/nano metal particles 810 irradiated directly by the electromagnetic radiation, such that the micro/nano metal particles 810 will be fused and combined with the non-conductive support 200. The way of irradiating the electromagnetic radiation indirectly to heat the thin film 800 containing the micro/nano metal particles 810 further adopts a light absorber (not shown in the figure) in the thin film 800 containing the micro/nano metal particles 810. Thus, the temperature is increased to the required fusion temperature when the thin film 800 containing the micro/nano metal particles 810 is irradiated by the electromagnetic radiation. For example, the energy absorbed by the micro/nano metal particles 810 during the bombardment of the electromagnetic radiation is insufficient to reach the fusion temperature. At this moment, the light absorber (not shown in the figure) improves the energy absorption effect and converts the energy into required heat energy to increase the temperature of the micro/nano metal particles 810, so as to fuse and combine the micro/nano metal particles 810 onto the non-conductive support 200.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A molded interconnect device (MID) with a thermal conductive property, comprising:
a support element, being a non-conductive support or a metallizable support;
a thermal conductive element, disposed in the support element; and
a metallization layer, formed on a surface of the support element.

2. The molded interconnect device (MID) with a thermal conductive property as recited in claim 1, wherein a material of the thermal conductive element is a metal, a non-metal, or a combination thereof.

3. The molded interconnect device (MID) with a thermal conductive property as recited in claim 2, wherein the metal is one selected from the collection of lead, aluminum, gold, copper, tungsten, magnesium, molybdenum, zinc, silver, and any combination thereof.

4. The molded interconnect device (MID) with a thermal conductive property as recited in claim 2, wherein the non-metal is one selected from the collection of graphite, grapheme, diamond, carbon nanotube, carbon nanocapsule, nanofoam, fullerene, carbon nanocone, carbon nanohorn, carbon nanopipet, carbon microtree, beryllium oxide, aluminum oxide, boron nitride, aluminum nitride, magnesium oxide, silicon nitride, silicon carbide, and any combination thereof.

5. The molded interconnect device (MID) with a thermal conductive property as recited in claim 1, wherein the support element is the non-conductive support, and a material of the non-conductive support is thermoplastic synthetic resin, thermosetting synthetic resin, or a combination thereof.

6. The molded interconnect device (MID) with a thermal conductive property as recited in claim 1, wherein the support element is the non-conductive support, and the non-conductive support comprises at least one inorganic filler.

7. The molded interconnect device (MID) with a thermal conductive property as recited in claim 6, wherein a material of the inorganic filler is silicate, a silicate derivative, carbonate, a carbonate derivative, phosphate, a phosphate derivative, activated carbon, porous carbon, carbon nanotube, graphite, zeolite, clay mineral, ceramic powder, chitin or any combination thereof.

8. The molded interconnect device (MID) with a thermal conductive property as recited in claim 1, wherein the support element further comprises a heat column penetrated and disposed in the support element.

9. The molded interconnect device (MID) with a thermal conductive property as recited in claim 8, wherein a material of the heat column is lead, aluminum, gold, copper, tungsten, magnesium, molybdenum, zinc, silver, graphite, grapheme, diamond, carbon nanotube, carbon nanocapsule, nanofoam, fullerene, carbon nanocone, carbon nanohorn, carbon nanopipet, carbon microtree, beryllium oxide, aluminum oxide, boron nitride, aluminum nitride, magnesium oxide, silicon nitride, silicon carbide, or any combination thereof.

10. The molded interconnect device (MID) with a thermal conductive property as recited in claim 1, further comprising a non-conductive metal composite set in the support element or on the surface of the support element, and the support element being made of the non-conductive support, and the non-conductive metal composite producing a plurality of metal nuclei distributed on one of the surfaces of the non-conductive support after irradiating an electromagnetic radiation, and the metal nuclei constituting a catalyst needed for forming the metallization layer, and the non-conductive metal composite being a thermally stable inorganic oxide and comprising a higher oxide with a spinel structure.

11. The molded interconnect device (MID) with a thermal conductive property as recited in claim 10, wherein a material of the non-conductive metal composite is copper, silver, palladium, iron, nickel, vanadium, cobalt, zinc, platinum, iridium, osmium, rhodium, rhenium, ruthenium, tin or any combination thereof.

12. The molded interconnect device (MID) with a thermal conductive property as recited in claim 1, further comprising an electroplatable colloid set on the support element, and the support element being the non-conductive support, and the electroplatable colloid making the metal layer to be formed on the non-conductive support by electroplating directly.

13. The molded interconnect device (MID) with a thermal conductive property as recited in claim 12, wherein a material of the electroplatable colloid is palladium, carbon, graphite, conductive polymer, or any combination thereof.

14. The molded interconnect device (MID) with a thermal conductive property as recited in claim 1, wherein the metallization layer includes a thin film containing a micro/nano metal particle, and the thin film is formed on the support element, and the support element is the non-conductive support, and after the thin film is irradiated and heated by an electromagnetic radiation directly or indirectly, the micro/nano metal particle is fused and combined onto the non-conductive support to form the metallization layer.

15. The molded interconnect device (MID) with a thermal conductive property as recited in claim 14, wherein a material of the micro/nano metal particle is titanium, antimony, silver, palladium, iron, nickel, copper, vanadium, cobalt, zinc, platinum, iridium, osmium, rhodium, rhenium, ruthenium, tin, or any mixture or combination thereof.

16. A manufacturing method of a molded interconnect device (MID) with a thermal conductive property, comprising the steps of:
providing a support element and a thermal conductive element, wherein the support element is a non-conductive support or a metallizable support, and the thermal conductive element is disposed in the support element; and
providing a metallization layer, wherein the metallization layer is formed on a surface of the support element.

17. The manufacturing method of a molded interconnect device (MID) with a thermal conductive property as recited in claim 16, further comprising a step of etching the surface of the support element before the step of providing the metallization layer, wherein the etching step is performed by a physical etch, a chemical etch or a combination thereof.

18. The manufacturing method of a molded interconnect device (MID) with a thermal conductive property as recited in claim 17, wherein the physical etch is performed by a laser direct structuring (LDS), the LDS further provides and sets a non-conductive metal composite in the support element, and the support element is the non-conductive support; the non-conductive metal composite is irradiated to an electromagnetic radiation to produce a plurality of metal nuclei distributed on the surface of the non-conductive support to form the metallization layer, and the non-conductive metal composite is a thermally stable inorganic oxide and comprising a higher oxide with a spinel structure.

19. The manufacturing method of a molded interconnect device (MID) with a thermal conductive property as recited in claim 18, wherein a material of the non-conductive metal composite is copper, silver, palladium, iron, nickel, vanadium, cobalt, zinc, platinum, iridium, osmium, rhodium, rhenium, ruthenium, tin or any combination thereof.

20. The manufacturing method of a molded interconnect device (MID) with a thermal conductive property as recited in claim 17, further comprising steps of providing a metal catalyst and distributing the metal catalyst on the surface of the support element in order to form the metallization layer before the step of forming the metallization layer.

21. The manufacturing method of a molded interconnect device (MID) with a thermal conductive property as recited in claim 20, further comprising a step of providing a non-metallizable support containing the thermal conductive element before the step of providing the support element and the thermal conductive element or between the step of providing the support element and the thermal conductive element and the step of providing the metallization layer, wherein the non-metallizable support containing the thermal conductive element and the support element containing the thermal conductive element are formed by a double injection molding method, and the support element is the metallizable support.

22. The manufacturing method of a molded interconnect device (MID) with a thermal conductive property as recited in claim 20, further comprising steps of providing another non-conductive support containing the thermal conductive element and molding the support element containing the thermal conductive element with the non-conductive support containing the thermal conductive element by an insert injection molding method after the etching step, wherein the support element is the metallizable support.

23. The manufacturing method of a molded interconnect device (MID) with a thermal conductive property as recited in claim 20, further comprising steps of providing another non-conductive support containing the thermal conductive element and molding the non-conductive support containing the thermal conductive element with the another non-conductive support containing the thermal conductive element by an insert injection molding method after the step of forming the metallization layer.

24. The manufacturing method of a molded interconnect device (MID) with a thermal conductive property as recited in claim 20, wherein a material of the metal catalyst is silver, palladium, iron, nickel, copper, vanadium, cobalt, zinc, platinum, iridium, osmium, rhodium, rhenium, ruthenium, tin or any combination thereof.

25. The manufacturing method of a molded interconnect device (MID) with a thermal conductive property as recited in claim 16, wherein the metallization layer is formed by a direct electroplating method, and the support element is the non-conductive support; the direct electroplating method provides an electroplatable colloid set on the surface of the non-conductive support, and the electroplatable colloid makes the metallization layer to be formed on the surface of the non-conductive support by the direct electroplating.

26. The manufacturing method of a molded interconnect device (MID) with a thermal conductive property as recited in claim 25, wherein a material of the electroplatable colloid is palladium, carbon/graphite, conductive polymer, or any combination thereof.

27. The manufacturing method of a molded interconnect device (MID) with a thermal conductive property as recited in claim 25, further comprising a step of etching the surface of the non-conductive support before the step of providing the electroplatable colloid.

28. The manufacturing method of a molded interconnect device (MID) with a thermal conductive property as recited in claim 27, wherein after the metallization layer is formed on the surface of the non-conductive support by the direct electroplating method, another non-conductive support containing the thermal conductive element is provided, and the non-conductive support containing the metallization layer is formed on the other non-conductive support by an insert injection molding method.

29. The manufacturing method of a molded interconnect device (MID) with a thermal conductive property as recited in claim 27, further comprising a step of providing another non-conductive support containing the thermal conductive element before the metallization layer is formed on the surface of the non-conductive support by electroplating directly, and the non-conductive support is formed on the another non-conductive support by an insert injection molding method.

30. The manufacturing method of a molded interconnect device (MID) with a thermal conductive property as recited within claim 16, further comprising a step of setting a thin film containing a plurality of micro/nano metal particles onto the support element in the step of providing the metallization layer, wherein the support element is the non-conductive support, and after the thin film containing the micro/nano metal particles is irradiated and heated by an electromagnetic radiation directly or indirectly, the micro/nano metal particles are fused and combined onto the non-conductive support to provide the metallization layer.

31. The manufacturing method of a molded interconnect device (MID) with a thermal conductive property as recited in claim 30, wherein a material of the micro/nano metal particle is titanium, antimony, silver, palladium, iron, nickel, copper, vanadium, cobalt, zinc, platinum, iridium, osmium, rhodium, rhenium, ruthenium, tin or any mixture or combination thereof.

32. The manufacturing method of a molded interconnect device (MID) with a thermal conductive property as recited in claim 16, wherein the non-conductive support includes at least one inorganic filler.

33. The manufacturing method of a molded interconnect device (MID) with a thermal conductive property as recited in claim 32, wherein a material of the inorganic filler is silicate, a silicate derivative, carbonate, a carbonate derivative, phosphate, a phosphate derivative, activated carbon, porous carbon, carbon nanotube, graphite, zeolite, clay mineral, ceramic powder, chitin or any combination thereof.

34. The manufacturing method of a molded interconnect device (MID) with a thermal conductive property as recited in claim 16, wherein the support element further comprises a heat column penetrated and disposed into the support element.

35. The manufacturing method of a molded interconnect device (MID) with a thermal conductive property as recited in claim 34, wherein a material of the heat column is lead, aluminum, gold, copper, tungsten, magnesium, molybdenum, zinc, silver, graphite, grapheme, diamond, carbon nanotube, carbon nanocapsule, nanofoam, fullerene, carbon nanocone, carbon nanohorn, carbon nanopipet, carbon microtree, beryllium oxide, aluminum oxide, boron nitride, aluminum nitride, magnesium oxide, silicon nitride, silicon carbide, or any combination thereof.

36. The manufacturing method of a molded interconnect device (MID) with a thermal conductive property as recited in claim 16, wherein a material of the non-conductive support is thermoplastic synthetic resin, thermosetting synthetic resin or a combination thereof.

37. The manufacturing method of a molded interconnect device (MID) with a thermal conductive property as recited in claim 16, wherein a material of the thermal conductive element is a metal, a non-metal, or a combination thereof.

38. The manufacturing method of a molded interconnect device (MID) with a thermal conductive property as recited in claim 37, wherein the metal is one selected from the collection of lead, aluminum, gold, copper, tungsten, magnesium, molybdenum, zinc, silver, and any combination thereof.

39. The manufacturing method of a molded interconnect device (MID) with a thermal conductive property as recited in claim 37, wherein the non-metal is one selected from the collection of graphite, grapheme, diamond, carbon nanotube, carbon nanocapsule, nanofoam, fullerene, carbon nanocone, carbon nanohorn, carbon nanopipet, carbon microtree, beryllium oxide, aluminum oxide, boron nitride, aluminum nitride, magnesium oxide, silicon nitride, silicon carbide, and any combination thereof.
